(19) United States
(12) Patent Application Publication
(10) Pub. No.: US 2025/0028053 A1
(43) Pub. Date: Jan. 23, 2025

(54) VEHICLE POSITION ESTIMATION SYSTEM

(71) Applicant: AISIN CORPORATION, Kariya, Aichi (JP)

(72) Inventor: Ryota KIMURA, Kariya-shi, Aichi-ken (JP)

(73) Assignee: AISIN CORPORATION, Kariya, Aichi (JP)

(21) Appl. No.: 18/715,397

(22) PCT Filed: Feb. 15, 2023
(86) PCT No.: PCT/JP2023/005139

§ 371 Date: May 31, 2024

(30) Foreign Application Priority Data
Feb. 22, 2022 (JP) 2022-025759

(51) Int. Cl. G01S 19/07; G06V 20/56

(52) U.S. Cl. CPC G01S 19/07; G06V 20/588

(57) ABSTRACT

There is provided a technique for increasing the possibility of being able to prevent deterioration in the accuracy of estimation of a vehicle position. A vehicle position estimation system includes a first error obtaining part that obtains a first error indicating an error in Global Navigation Satellite System (GNSS) information obtained by a vehicle; a second error obtaining part that obtains a second error indicating an autonomous navigation error; a third error obtaining part that obtains a third error indicating an error occurring upon detecting a marking included in an image obtained by photographing a road around the vehicle; and a position estimating part that selects a position estimation method with a smallest error among the first error, the second error, and the third error, and estimates a position of the vehicle in a width direction of the road, using a selected position estimation method.

### CROSS REFERENCE TO RELATED APPLICATIONS

This application is a National Stage of International Application No. PCT/JP2023/005139 filed on Feb. 15, 2023, claiming priority based on Japanese Patent Application No. 2022-025759 filed on Feb. 22, 2022, the entire contents of which are incorporated in their entirety.

### Technical Field

The present disclosure relates to a vehicle position estimation system.

### Background Art

Conventionally, there is known a technique in which when a difference between a position estimated by GNSS information and a position estimated by autonomous navigation is greater than a predetermined reference, the position estimated by autonomous navigation is corrected to the position estimated by GNSS information (e.g., Patent Literature 1).

### CITATIONS LIST

### Patent Literature

Patent Literature 1: JP H11-230772 A

### SUMMARY OF THE DISCLOSURE

### Technical Problems

However, in the conventional technique, a configuration is adopted in which when a predetermined condition is met, e.g., a difference between positions is greater than a reference, the position of a vehicle is corrected, and thus, there has been a problem that the position of the vehicle is not corrected during a period before the predetermined condition is met.

Aspects of the present disclosure are made in view of the above-described problem, and provides a technique for increasing the possibility of being able to prevent deterioration in the accuracy of estimation of a vehicle position.

### SOLUTIONS TO PROBLEMS

To provide the above-described technique, a vehicle position estimation system includes: a first error obtaining part that obtains a first error indicating an error in Global Navigation Satellite System (GNSS) information obtained by a vehicle; a second error obtaining part that obtains a second error indicating an autonomous navigation error; a third error obtaining part that obtains a third error indicating an error occurring upon detecting a marking included in an image obtained by photographing a road around the vehicle; and a position estimating part that selects a position estimation method with a smallest error among the first error, the second error, and the third error, and estimates a position of the vehicle in a width direction of the road, using a selected position estimation method.

Namely, in the vehicle position estimation system, a comparison is made between a first error, a second error, and a third error to select a position estimation method with the smallest error among the three errors, and a position of a vehicle in a width direction of a road is estimated using the selected position estimation method. Hence, the position of the vehicle in the width direction of the road can be estimated by a position estimation method that is estimated to have the smallest error (an error in the width direction of the road) in an actual vehicle position among three position estimation methods. As a result, the possibility of being able to prevent deterioration in the accuracy of estimation of a vehicle position by continuing position estimation that adopts the same position estimation method can be increased.

### BRIEF DESCRIPTION OF DRAWINGS

FIG. 1 is a block diagram showing a configuration of a vehicle position estimation system.

FIG. 2A is a diagram showing an example of a photographed image and FIG. 2B is a diagram that describes a depth position setting.

FIG. 3 is a diagram showing vehicle position estimation methods used to update a vehicle position in each direction.

FIG. 4A is a flowchart of a vehicle position estimation process, FIG. 4B is a flowchart of a vehicle position update data setting process, FIG. 4C is a flowchart of a various types of data obtaining process, and FIG. 4D is a flowchart of a second error obtaining process.

FIG. 5A is a flowchart of a first error obtaining process, FIG. 5B is a flowchart of a vehicle's front-back position update setting process, and FIG. 5C is a flowchart of a vehicle position update process.

FIG. 6 is a flowchart of a third error obtaining process.

FIG. 7 is a flowchart of a vehicle's left-right position update setting process.

### DESCRIPTION OF EMBODIMENTS

Here, an embodiment of the present disclosure will be described in accordance with the following order:
(1) Configuration of a vehicle position estimation system;
(2) Vehicle position estimation process; and
(3) Other embodiments.

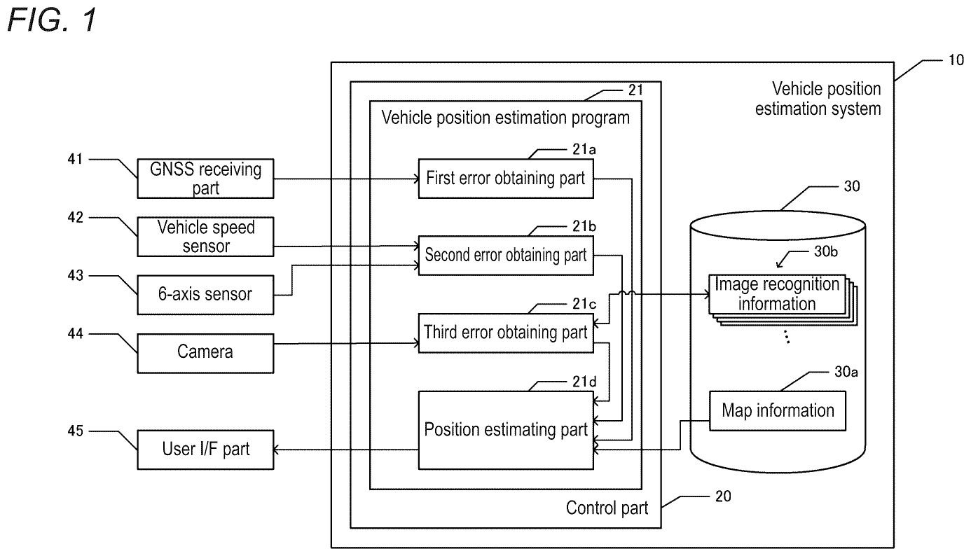

(1) Configuration of a vehicle position estimation system: FIG. 1 is a block diagram showing a configuration of a vehicle position estimation system 10 according to one embodiment of the present disclosure. The vehicle position estimation system 10 is provided in a vehicle and includes a control part 20 including a CPU, a RAM, a ROM, etc.; and a recording medium 30. The vehicle position estimation system 10 can execute, by the control part 20, a program stored in the recording medium 30 or the ROM.

The recording medium 30 has map information 30a recorded therein in advance. The map information 30a is, in the present embodiment, information used for estimation of a vehicle position, and includes node data representing the positions, etc., of nodes set on roads on which the vehicle travels; shape interpolation point data representing the positions, etc., of shape interpolation points for identifying the geometry of a road between nodes; link data representing a link between nodes; ground object data representing the positions, etc., of ground objects present on roads or around the roads; etc. In the present embodiment, lane data is associated with the link data. The lane data is information about lanes present on a road, and includes information indicating the number of lanes present on a road section corresponding to a link and the widths of the lanes, and information indicating the types of markings on the left and right sides of the lanes and other conditions. In addition, when the number of lanes or the lane width changes in the middle of the link, a position where the change is made is included in the lane data. The control part 20 can identify the number of lanes and lane width at an estimated vehicle position, based on the lane data.

The vehicle of the present embodiment includes a GNSS receiving part 41, a vehicle speed sensor 42, a 6-axis sensor 43, a camera 44, and a user I/F part 45. The camera 44 photographs an area ahead of the vehicle. An optical axis of the camera 44 is fixed on the vehicle, and the direction of the optical axis is to be known by the vehicle position estimation system 10. In the present embodiment, the camera 44 is fixed such that a width direction of the vehicle is perpendicular to the center of the optical axis and the center of the optical axis passes through the center in the width direction of the vehicle. In addition, the camera 44 is mounted on the vehicle in a posture in which an area ahead in a traveling direction of the vehicle is included in the field of view. The control part 20 obtains an image outputted from the camera 44 and analyzes the image, by which road markings ahead of the vehicle can be detected.

The user I/F part 45 is an interface part for accepting, as input, instructions from an occupant and providing various types of information to the occupant, and includes a display part including a touch panel display, an input part such as switches, and an audio output part such as a speaker, which are not shown. The user I/F part 45 receives a control signal from the control part 20 and displays, on the touch panel display, a map including a current position of the vehicle or an image for providing various types of guidance such as a planned travel route.

The GNSS receiving part 41 is a device that receives Global Navigation Satellite System signals. The GNSS receiving part 41 adopts Real Time Kinematics Global Navigation Satellite System (RTK-GNSS), and detects a position with an accuracy of a few centimeters by correcting a result of detection obtained based on signals received from satellites, using correction information received from a fixed reference station of the GNSS. When the GNSS receiving part 41 is in a state of detecting a position using correction information received from the fixed reference station of the GNSS (hereinafter, referred to as RTK-FIX), the GNSS receiving part 41 outputs GNSS information including status information indicating that the GNSS receiving part 41 is in an RTK-FIX state, a detected position, and information indicating an error range (error circle) with respect to the position.

The vehicle speed sensor 42 outputs a signal corresponding to the rotational speed of wheels provided on the vehicle. The control part 20 obtains the signal through an interface which is not shown, thereby obtaining a vehicle speed. The 6-axis sensor 43 includes acceleration sensors with three axes (front-back, left-right, and up-down) defined in the vehicle and gyro sensors with the three axes, and outputs, for each of the three axes, a signal indicating acceleration and a signal indicating angular velocity. The control part 20 obtains the signals indicating 3-axis angular velocities, thereby obtaining a traveling direction of the vehicle.

The control part 20 continuously estimates a vehicle position in predetermined cycles by executing a vehicle position estimation program 21, and accumulates, as a travel path, a path of vehicle positions for the respective cycles. The control part 20 identifies a link on which the vehicle is traveling, by map matching using the map information 30a. The vehicle position estimation program 21 includes functions of a first error obtaining part 21a, a second error obtaining part 21b, a third error obtaining part 21c, and a position estimating part 21d so that the control part 20 implements a function of preventing deterioration in the accuracy of estimation of a vehicle position.

By a function of the first error obtaining part 21a, the control part 20 obtains a first error indicating a position error in GNSS information obtained by the vehicle. In the present embodiment, the control part 20 obtains GNSS information from the GNSS receiving part 41 every predetermined cycle. Then, the control part 20 obtains a position included in the GNSS information, as one candidate for updating the latest vehicle position. In addition, when status information indicates that it is in an RTK-FIX state, the control part 20 obtains an error circle radius as a first error. An error in the width direction (left-right direction) of the vehicle is represented by the first error (an error in a front-back direction is also represented by the first error). Namely, the first error indicates the reliability of the position of the vehicle when the position is estimated based on GNSS information. The smaller the first error, the higher the reliability of the position in the width direction of the vehicle and the higher the reliability of the position of the vehicle in a width direction of a road.

By a function of the second error obtaining part 21b, the control part 20 obtains second errors indicating autonomous navigation errors. In the present embodiment, the control part 20 identifies a vehicle's travel path every predetermined cycle, using a vehicle speed and a traveling direction that are obtained from output from the vehicle speed sensor 42 and the 6-axis sensor 43. The control part 20 obtains a position identified based on a base point and a travel path from the base point, as one candidate for updating the latest vehicle position. Errors in such a position of the vehicle identified by autonomous navigation are accumulated more and increase as the distance traveled from the base point increases. For errors in the front-back direction of the vehicle and errors in the left-right direction (width direction) of the vehicle, an error per unit distance is stored in advance. The control part 20 calculates, from a distance traveled from the position of the vehicle updated last time and errors per unit distance, errors in the front-back direction and in the left-right direction that are accumulated while the vehicle travels the distance traveled. Then, the control part 20 obtains, as second errors, errors that are used when the position of the vehicle is updated by autonomous navigation in the current cycle and that are values obtained by adding the errors in the front-back direction and in the left-right direction that are accumulated while the vehicle travels the distance traveled to errors in the front-back direction and in the left-right direction of the vehicle that are updated last time. The second errors are obtained for the respective front-back direction and left-right direction (the width direction of the vehicle). Namely, the second errors indicate the reliability of the position of the vehicle when the position is estimated by autonomous navigation. The smaller the second errors, the higher the reliability of the position in the width direction of the vehicle and the higher the reliability of the position of the vehicle in a width direction of a road.

By a function of the third error obtaining part 21c, the control part 20 obtains a third error indicating an error occurring upon detecting markings included in an image obtained by photographing a road around the vehicle. In the present embodiment, in the control part 20, the control part 20 performs a marking recognition process based on an image photographed by the camera 44. In the marking recognition process, a marking is recognized by, for example, performing semantic segmentation. Namely, the control part 20 inputs an image into a machine-trained model which is prepared in advance, thereby labeling, for each pixel, the pixel with the type of a photographed subject. The labels include markings, and when pixels labeled as a marking around the vehicle extend in a direction parallel to a traveling direction of the vehicle and form a solid line or a broken line, the control part 20 considers the pixels to be a marking which is a lane boundary. The control part 20 considers the closest markings present on the left and right of the vehicle to be markings indicating boundaries of a lane in which the vehicle is traveling. In addition, the control part 20 detects the types of the markings indicating the boundaries of the lane in which the vehicle is traveling. When there are other markings extending in the direction parallel to the traveling direction, the control part 20 identifies the number of lanes included in a road on which the vehicle is traveling, based on the positions and number of the markings, and identifies a position of a lane in which the vehicle is traveling among the plurality of lanes. Note that the marking recognition process may be Hough transform, image processing that extracts features of markings, etc., in addition to semantic segmentation.

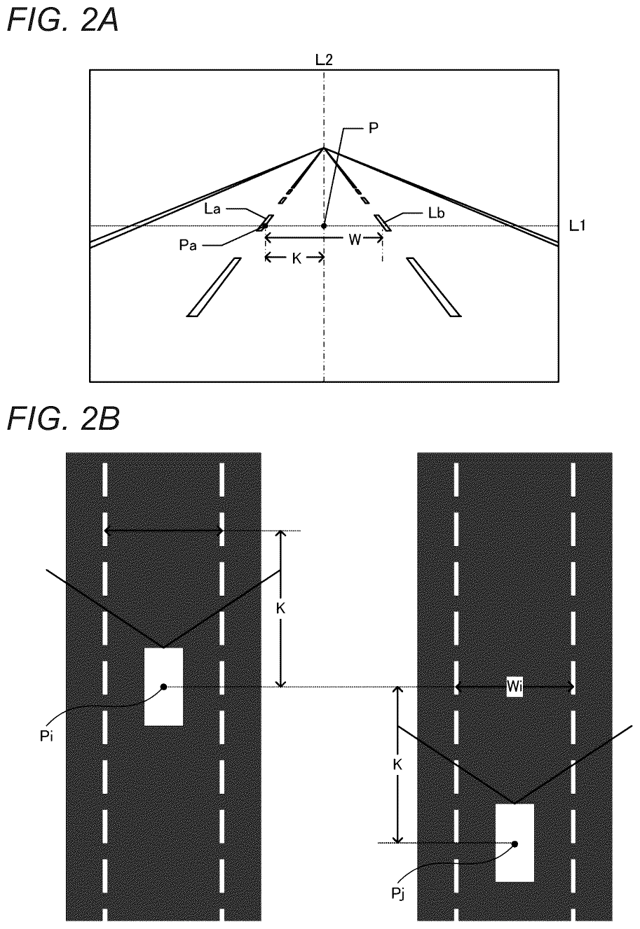

The control part 20 calculates a lane width of a lane in which the vehicle is traveling, based on an image. In the present embodiment, a lane width at a position ahead of the vehicle that is determined in advance as a depth position setting is obtained. For each set of coordinates of each pixel in an image, a relative distance between a photographed subject and the vehicle is associated in advance with each pixel. FIG. 2A is a diagram showing an example of an image photographed by the camera 44, and description continues assuming that the image is photographed when the vehicle is present at a point Pi of FIG. 2B. The depth position setting is a position a distance K away forward from the position of the vehicle. The control part 20 identifies, in the image, pixels at a position with a distance corresponding to the depth position setting. A broken line L1 of FIG. 2A indicates pixels corresponding to a position the distance K away forward from the vehicle.

At the position of the broken line LI in the image, a correspondence between an actual distance in a left-right direction on a road surface corresponding to the number of pixels in a horizontal direction in the image is identified in advance. Based on the correspondence, the control part 20 identifies, as the lane width of a lane in which the vehicle is traveling, a distance W corresponding to the number of pixels between two closest markings La and Lb present on the left and right of the vehicle at the position of the broken line L1 in the image. A dash-dotted line L2 of FIG. 2A indicates the center of the optical axis of the camera 44. The control part 20 identifies distances between the closest markings present on the left and right of the vehicle and the center in the width direction of the vehicle, thereby obtaining a position, in a width direction of a road, of the vehicle with respect to the markings in a driving lane. Specifically, for example, a distance K corresponding to the number of pixels between a point of intersection Pa of either one of the left and right markings (e.g., La) in a driving lane of the vehicle and the broken line Ll and a point of intersection P of the broken line L1 and the dash-dotted line L2 is calculated as a distance between the driving lane and the vehicle.

The control part 20 calculates, from an image, markings on a road on which the vehicle is traveling, a lane width of a lane in which the vehicle is traveling, and a relative position from a marking in the lane in which the vehicle is traveling (a position in the width direction of the road), and accumulates, as image recognition information 30b, the markings, the lane width, and the relative position in chronological order such that the image recognition information 30b is associated with a photographing cycle of the image.

As shown in FIG. 2B, an image photographed when the vehicle is located at the point Pi does not include a road surface at the point Pi. The position of the vehicle (the position in the width direction of the road) at the point Pi can be obtained by performing image recognition on an image that is photographed before the vehicle reaches the point Pi (in the past) and that is photographed at a point Pj where the distance between the position of the vehicle and the point Pi upon photographing the image is K. The control part 20 calculates, based on a vehicle speed obtained in predetermined cycles, a distance traveled by the vehicle for each cycle. Since the camera 44 photographs an image in predetermined cycles, the control part 20 can identify how many cycles ago the image including the point Pj the distance K away rearward in a traveling direction from the point Pi is photographed. The control part 20 obtains image recognition information 30b of a thus identified image from the recording medium 30, thereby obtaining the position of the vehicle (the position in the width direction of the road) at the point Pi and a lane width Wi at the point Pi.

The control part 20 compares the lane width Wi at the point Pi which is thus calculated based on the image recognition information 30b of the image including the point Pi where the vehicle is currently located (a point where the vehicle is located in the latest cycle), with a lane width wi at a point identified based on the map information 30a. Namely, the control part 20 obtains the lane width wi of a lane in which the vehicle is traveling, by referring to link data (map information 30a) of a link that the vehicle matches. Then, the control part 20 obtains a difference between the lane width Wi and the lane width wi as a third error. Namely, the third error indicates reliability when a relative position of the vehicle in the width direction of the road is obtained by image recognition. The smaller the third error, the higher the reliability of the relative position.

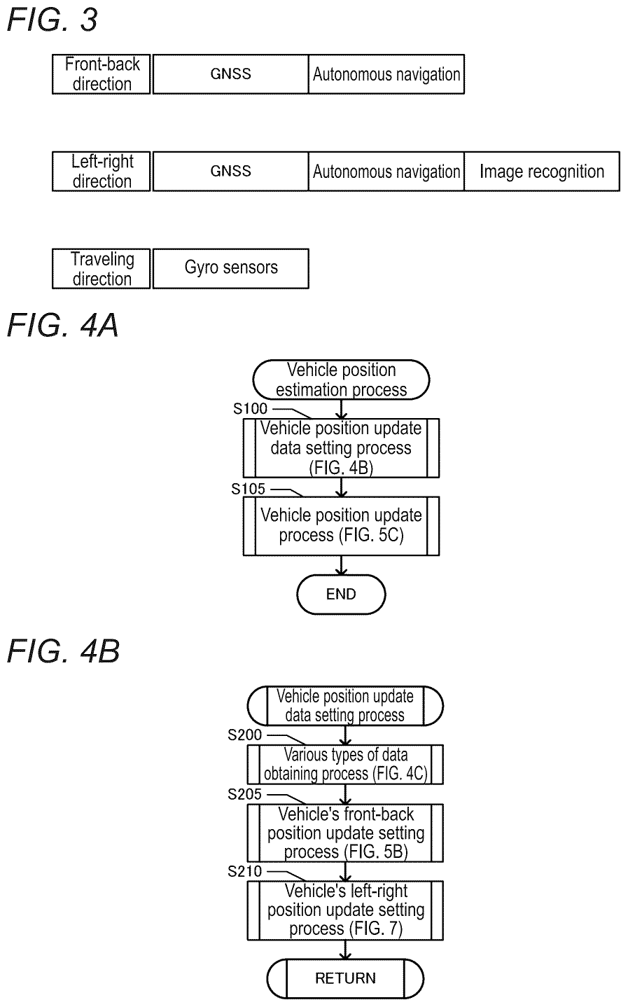

By a function of the position estimating part 21d, the control part 20 selects a position estimation method with the smallest error among the first error, the second errors, and the third error, and estimates the position of the vehicle in the width direction of the road, using the selected position estimation method. In the present embodiment, as shown in FIG. 3, the position in the front-back direction is updated to a position calculated by a position estimation method with a smaller error between GNSS and autonomous navigation. Namely, when the first error is smaller, GNSS is selected, and when the second errors are smaller, autonomous navigation is selected. In addition, the position in the left-right direction (the width direction of the road) is updated to a position calculated by a position estimation method with the smallest error among GNSS, autonomous navigation, and image recognition. When image recognition is selected as a position estimation method for updating the position in the left-right direction (the width direction of the road), the position, in the width direction of the road, of the vehicle is updated using a result of image recognition for an image photographed at the point Pj the distance K away rearward from the point Pi where the vehicle is located in a corresponding cycle. When the vehicle travels along the geometry of the lane between the point Pj and the point Pi, it can be estimated that the position in the width direction determined based on the image photographed at the point Pj maintains the same position in the width direction at timing, too, at which the vehicle has reached the point Pi. If the traveling direction of the vehicle is inclined relative to a direction in which the lane extends at the point Pj (if the vehicle travels in a direction in which the vehicle deviates from the lane), then the third error which is the difference between the lane width Wi obtained by image recognition and the lane width wi based on the map information 30a tends to increase, and thus, image recognition is less likely to be selected as a position estimation method for updating the position of the vehicle in the width direction of the road.

Note that for the traveling direction, as shown in FIG. 3, in the present embodiment, a traveling direction based on output from the gyro sensors included in the 6-axis sensor 43 is adopted.

As described above, the vehicle position estimation system 10 of the present embodiment is configured to select a method with the smallest error among a plurality of position estimation methods every predetermined cycle, and update the latest vehicle position. As a result, the possibility of being able to prevent deterioration in the accuracy of estimation of a vehicle position which is caused by estimation of the position by adopting the same position estimation method can be increased. In addition, in the present embodiment, a first error, second errors, and a third error are obtained in predetermined cycles, a position estimation method corresponding to a method with the smallest error among the first to third errors is selected in the predetermined cycles, and a position is estimated by the selected method. If at least any one of the first to third errors is obtained in longer cycles than the predetermined cycles, then there is a possibility that a position estimation method that actually has the smallest error may not be selected, and as a result, the accuracy of position estimation can decrease. In the present embodiment, by obtaining the first to third errors in the predetermined cycles, the possibility of a reduction in the accuracy of position estimation can be reduced. It is desirable that the cycles of obtaining the first to third errors be, as in the present embodiment, the same as predetermined cycles which are the cycles of estimating a vehicle position or be shorter cycles than the predetermined cycles (the frequency is higher than that for estimation of a vehicle position).

(2) Vehicle position estimation process:

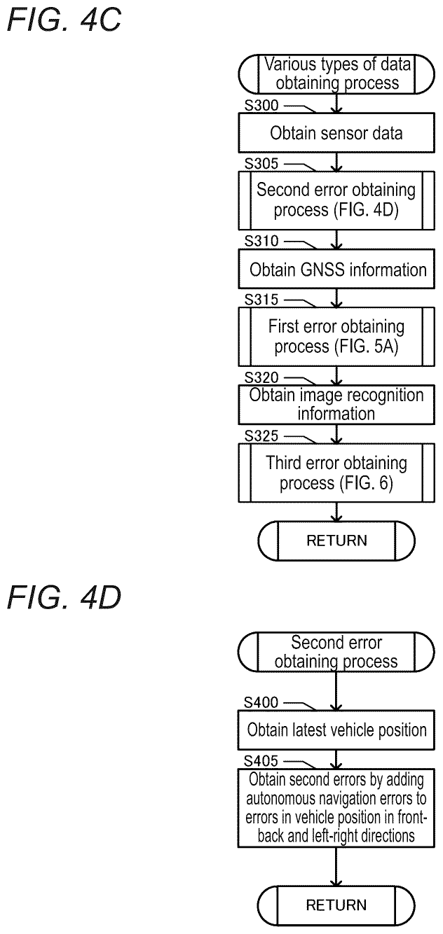

Next, a vehicle position estimation process performed by the control part 20 will be described with reference to FIG. 4A. The vehicle position estimation process is repeatedly performed in predetermined cycles. In the vehicle position estimation process, the control part 20 performs a vehicle position update data setting process (step S100) and then performs a vehicle position update process (step S105). The vehicle position update data setting process at step S100 is a process in which a first error, second errors, and a third error are obtained and compared in magnitude with each other to select a vehicle position estimation method for each of the front-back direction and the left-right direction. The vehicle position update process at step S105 is a process in which the vehicle position is updated by a vehicle position estimation method selected according to a result of the comparison.

FIG. 4B is a flowchart of the vehicle position update data setting process at step S100 of the vehicle position estimation process of FIG. 4A. In the vehicle position update data setting process, the control part 20 performs a various types of data obtaining process (step S200). Subsequently, by the function of the position estimating part 21d, the control part 20 performs a vehicle's front-back position update setting process (step S205) and a vehicle's left-right position update setting process (step S210) in turn.

FIG. 4C is a flowchart of the various types of data obtaining process at step S200 of the vehicle position update data setting process of FIG. 4B. When the various types of data obtaining process starts, by the function of the second error obtaining part 21b, the control part 20 obtains sensor data from the vehicle speed sensor 42 and the 6-axis sensor 43 (step S300) and performs a second error obtaining process based on the obtained sensor data (step S305).

Subsequently, by the function of the first error obtaining part 21a, the control part 20 obtains GNSS information (step S310) and performs a first error obtaining process based on the obtained GNSS information (step S315). The GNSS information obtained at step S310 includes status information, a vehicle position, and information indicating an error circle.

Subsequently, by the function of the third error obtaining part 21c, the control part 20 obtains image recognition information (step S320) and performs a third error obtaining process based on the obtained image recognition information (step S325). The image recognition information 30b obtained at step S320 is accumulated in chronological order in the recording medium 30 such that the lane width of a lane is associated with a photographing cycle.

FIG. 4D is a flowchart of the second error obtaining process at step S305 of FIG. 4C. In the second error obtaining process, the control part 20 obtains the latest vehicle position obtained in the last cycle (step S400), and obtains second errors by adding autonomous navigation errors to errors in the latest vehicle position in the front-back and left-right directions (step S405). Namely, the control part 20 calculates second errors (front-back and left-right) by adding autonomous navigation errors based on a distance traveled from the last latest position to errors for the latest position of the vehicle that is updated last time.

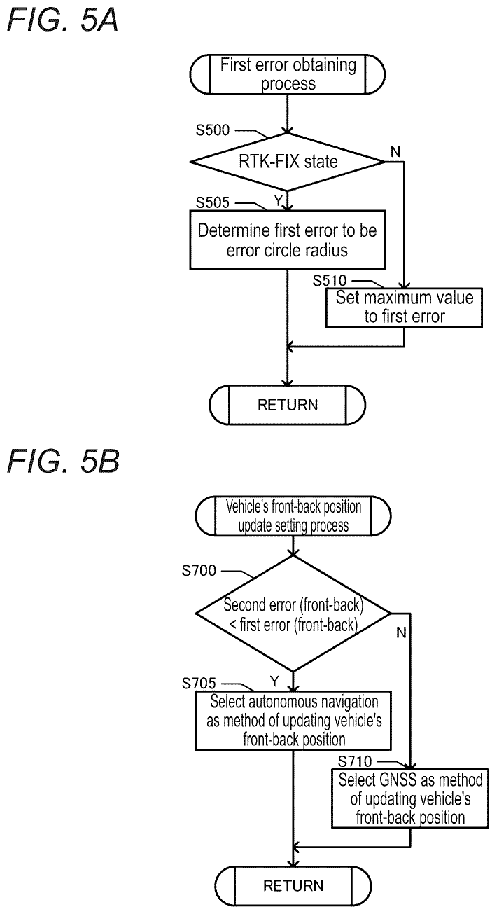

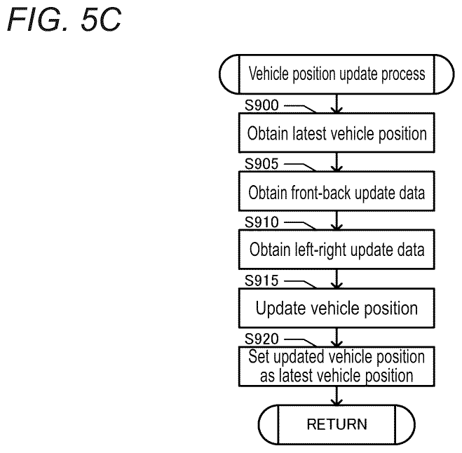

FIG. 5A is a flowchart of the first error obtaining process at step S315 of FIG. 4C. In the first error obtaining process, the control part 20 determines whether or not it is in an RTK-FIX state, by referring to the status information included in the GNSS information obtained at step S310 of FIG. 4C (step S500). If it is determined at step S500 that it is in an RTK-FIX state, then the control part 20 determines a first error to be an error circle radius (step S505). If it is not determined at step S500 that it is in an RTK-FIX state, then the control part 20 sets a maximum value to the first error (step S510). The maximum value is a maximum value assumed in advance as an error circle of GNSS. Thus, when it is not in an RTK-FIX state, GNSS is less likely to be selected as a method of estimating a vehicle position in the front-back direction.

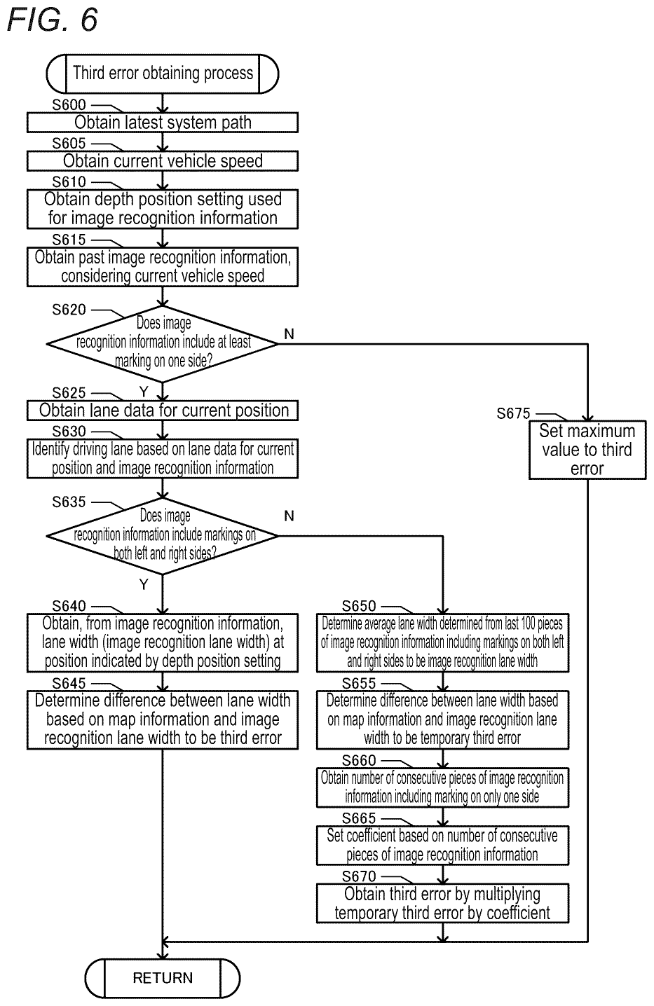

FIG. 6 is a flowchart of the third error obtaining process at step S325 of FIG. 4C. When the third error obtaining process starts, the control part 20 obtains the latest vehicle position obtained in the last cycle (step S600). Namely, the control part 20 obtains, as the latest vehicle position, the same position as that obtained at step S400 of the second error obtaining process of FIG. 4D.

Subsequently, the control part 20 obtains a current vehicle speed (step S605). Namely, the control part 20 obtains the latest vehicle speed based on output from the vehicle speed sensor 42. Subsequently, the control part 20 obtains a depth position setting which is used for image recognition information (step S610). Namely, the control part 20 obtains a distance K (see FIG. 2B).

Subsequently, the control part 20 obtains past image recognition information, considering the current vehicle speed (step S615). Namely, the control part 20 identifies a photographing cycle in which a point where the vehicle is currently located is photographed at a position corresponding to the depth position setting in an image among pieces of image recognition information 30b accumulated in the recording medium 30, and obtains image recognition information 30b of an image photographed in the photographing cycle.

Subsequently, the control part 20 determines whether or not the image recognition information includes at least a marking on one side (step S620). Namely, the control part 20 determines whether or not at least one marking along a road on which the vehicle is traveling is detected, by referring to the past image recognition information obtained at step S615. If it is not determined at step S620 that there is at least a marking on one side, i.e., if there are no markings on both left and right sides, then the control part 20 sets a maximum value to a third error (left-right) (step S675). The maximum value is a maximum value that can be assumed in advance as a difference between a lane width obtained by image recognition and a lane width at the current position obtained based on map information. Thus, in this case, image recognition is less likely to be selected as a method of estimating a position in the width direction.

If it is determined at step S620 that there is at least a marking on one side, then the control part 20 obtains lane data for the current position (step S625). Namely, the control part 20 identifies a link that matches the latest vehicle position obtained at step S600, using the map information 30a, and obtains the number of lanes included in the link, the lane width and type of each lane, etc., by referring to lane data of the link.

Subsequently, the control part 20 identifies a driving lane, based on the lane data for the current position and the image recognition information (step S630). Namely, the control part 20 identifies a position of a driving lane (leftmost, center, etc. toward the front in a traveling direction) among the lanes included in the matching link, based on information about markings on a road on which the vehicle is traveling (the types of the closest markings present on the left and right of the vehicle, the positions and types of other markings, etc.) which is included in the image recognition information.

Subsequently, the control part 20 determines whether or not the image recognition information includes markings on both left and right sides (step S635). If it is determined at step S635 that there are markings on both left and right sides, then the control part 20 obtains a lane width (image recognition lane width) at a position indicated by the depth position setting, from the image recognition information (step S640). Namely, a lane width of a lane in which the vehicle is traveling is obtained based on image recognition information of an image including the point where the vehicle is currently located among the pieces of accumulated image recognition information. Subsequently, the control part 20 determines a difference between the lane width based on the map information and the image recognition lane width to be a third error (step S645). Namely, a difference between the lane width identified at step S625 and S630 and the image recognition lane width obtained at step S640 is a third error.

If it is not determined at step S635 that there are markings on both left and right sides, i.e., if a marking on either one of the left and right sides is not being detected, then the control part 20 determines an average lane width determined from the last 100 pieces of image recognition information including markings on both left and right sides to be an image recognition lane width (step S650). Namely, the control part 20 identifies the last 100 pieces of image recognition information including markings on both left and right sides by tracing the pieces of image recognition information 30b accumulated in the recording medium 30 further back to the past in turn from the image recognition information for the cycle which is obtained at step S615, calculates an average lane width from the 100 pieces of image recognition information, and determines the average lane width to be an image recognition lane width.

Subsequently, the control part 20 determines a difference between the lane width based on the map information and the image recognition lane width to be a temporary third error (step S655). Namely, a difference between the lane width identified at step S625 and S630 and the image recognition lane width obtained at step S650 is a temporary third error. Subsequently, the control part 20 obtains the number of consecutive pieces of image recognition information including a marking on only one side (step S660). Namely, the control part 20 obtains the number of consecutive pieces of image recognition information in which a marking is detected only on one side, by tracing the pieces of image recognition information further back to the past from the image recognition information obtained at step S615. Subsequently, the control part 20 sets a coefficient based on the number of consecutive pieces of image recognition information (step S665). Namely, the control part 20 sets a coefficient based on the number consecutive pieces of image recognition information obtained at step S660. A larger coefficient value is set for a larger number of consecutive pieces of image recognition information than for a smaller number of consecutive pieces of image recognition information. Subsequently, the control part 20 obtains a third error by multiplying the temporary third error by the coefficient (step S670). Namely, the control part 20 calculates a third error by multiplying the temporary third error obtained at step S655 by the coefficient obtained at step S665. Note that the above-described method of calculating a third error which is adopted when there is a marking on only either one of the left and right sides is an example, and various other methods can also be adopted. The process described above is the third error obtaining process, and the various types of data obtaining process of FIG. 4C ends here.

FIG. 5B is a flowchart of the vehicle's front-back position update setting process at step S205 of FIG. 4B. The process is a process in which a comparison is made between the first error and the second error for the front-back direction and a position estimation method with a smaller one of the first error and the second error is selected as a method of updating a position in the front-back direction. Namely, the control part 20 determines whether or not the second error (front-back) is smaller than the first error (front-back) (step S700). Namely, it is determined whether or not an error in the front-back direction occurring when a position is estimated by adopting autonomous navigation is smaller than an error in the front-back direction occurring when a position is estimated using GNSS information. If it is determined at step S700 that the second error is smaller than the first error, then the control part 20 selects autonomous navigation as a method of updating a vehicle's front-back position (step S705). If it is not determined at step S700 that the second error is smaller than the first error, then the control part 20 selects GNSS as a method of updating a vehicle's front-back position (step S710).

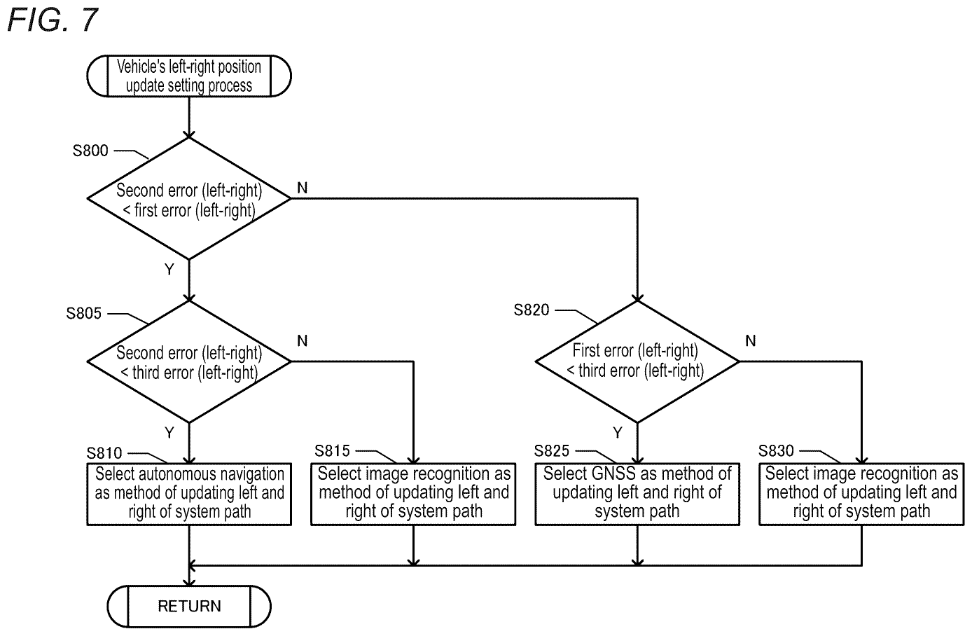

FIG. 7 is a flowchart of the vehicle's left-right position update setting process at step S210 of FIG. 4B. The process is a process in which a comparison is made between the first error, the second error, and the third error for the left-right direction (the width direction of the vehicle) and a position estimation method with the smallest error is selected as a method of updating a position in the left-right direction. Namely, the control part 20 determines whether or not the second error (left-right) is smaller than the first error (left-right) (step S800). If it is determined at step S800 that the second error (left-right) is smaller than the first error (left-right), then the control part 20 determines whether or not the second error (left-right) is smaller than the third error (left-right) (step S805). If it is determined at step S805 that the second error (left-right) is smaller than the third error (left-right), i.e., if the second error (left-right) is smaller than either of the first error (left-right) and the third error (left-right), then the control part 20 selects autonomous navigation as a method of updating a vehicle position in the width direction (step S810).

If it is not determined at step S805 that the second error (left-right) is smaller than the third error (left-right), i.e., if the third error (left-right) is smaller than either of the first error (left-right) and the second error (left-right), then the control part 20 selects image recognition as a method of updating a vehicle position in the width direction (step S815).

If it is not determined at step S800 that the second error (left-right) is smaller than the first error (left-right), then the control part 20 determines whether or not the first error (left-right) is smaller than the third error (left-right) (step S820). If it is determined at step S820 that the first error (left-right) is smaller than the third error (left-right), i.e., if the first error (left-right) is smaller than either of the second error (left-right) and the third error (left-right), then the control part 20 selects GNSS as a method of updating a vehicle's left-right position (step S825). If it is not determined at step S820 that the first error (left-right) is smaller than the third error (left-right), i.e., if the third error (left-right) is smaller than either of the first error (left-right) and the second error (left-right), then the control part 20 selects image recognition as a method of updating a vehicle's left-right position (step S830).

FIG. 5C is a flowchart of the vehicle position update process at step S105 of FIG. 4A. By the function of the position estimating part 21d, the control part 20 performs a vehicle position update process. When the vehicle position update process starts, the control part 20 obtains the latest vehicle position (step S900). Namely, the control part 20 obtains the latest vehicle position that is updated in the last vehicle position update process. Subsequently, the control part 20 obtains front-back update data (step S905). Namely, the control part 20 obtains, as front-back update data, a component of the position of the vehicle in a direction parallel to the traveling direction, which is the position of the vehicle estimated by the method selected in the vehicle's front-back position update setting process of FIG. 5B.

Subsequently, the control part 20 obtains left-right update data (step S910). Namely, the control part 20 obtains, as left-right update data, a component of the position of the vehicle in a direction orthogonal to the traveling direction, which is the position of the vehicle estimated by the method selected in the vehicle's left-right position update setting process of FIG. 7.

Subsequently, the control part 20 updates the vehicle position (step S915) and sets the updated vehicle position as the latest vehicle position (step S920). Namely, the control part 20 determines a vehicle position updated with the front-back update data obtained at step S905 and the left-right update data obtained at step S910 to be the latest vehicle position.

(3) Other embodiments:

The above-described embodiment is an example for implementing aspects of the present disclosure, and various other embodiments can also be adopted. For example, the vehicle position estimation system may be a device implemented by a plurality of devices. Some components in the above-described embodiment may be omitted or the order of processes may be changed or omitted. Furthermore, at least one of the first error obtaining part 21a, the second error obtaining part 21b, the third error obtaining part 21c, and the position estimating part 21d that are included in the vehicle position estimation system may be present separated into a plurality of devices. For example, a part of the function of the third error obtaining part 21c may be implemented by another device having a camera integrated thereinto. Needless to say, some components in the above-described embodiment may be omitted or the order of processes may be changed or omitted.

For vehicle position estimation by autonomous navigation, a configuration may be adopted in which a traveling direction of the vehicle is obtained based on output from a 3-axis gyro sensor, and the moving speed and moving distance of the vehicle in the traveling direction are obtained based on output from a 3-axis acceleration sensor.

The third error may have any value as long as the third error has a value indicating an error in an estimated position for a case of estimating the position of the vehicle based on markings included in an image obtained by photographing a road around the vehicle. The vehicle may include various types of sensors other than a camera, e.g., a sensor such as LIDAR that senses an area around the vehicle, and a configuration may be adopted in which a third error is obtained by detecting markings using such a sensor. In addition, a configuration may be adopted in which a position in the width direction of a road is estimated by performing an image recognition process on the latest image. Specifically, for example, the latest image includes an image at a point the distance K ahead of a point where the vehicle is located upon photographing, and a configuration may be adopted in which the control part calculates, from the image, a lane width at the point the distance K ahead of the vehicle position, compares the lane width with a lane width of a driving lane identified from map information, and obtains a difference between the lane widths as a third error. Note that a camera or a sensor for calculating a third error is not limited to having a configuration in which the camera or sensor is included in the vehicle so as to sense a view ahead of the vehicle, and may be provided, for example, at the rear or at both sides.

The predetermined cycles may be cycles defined by time or may be cycles defined by distance. Namely, a configuration may be adopted in which a method with the smallest error among position estimation methods is selected every lapse of predetermined time, or a configuration may be adopted in which a method with the smallest error among position estimation methods is selected every vehicle's movement of a predetermined distance.

The position estimating part may be configured in any manner as long as a vehicle position can be estimated by a method selected in predetermined cycles and based on each error, and a first error, second errors, and a third error do not necessarily need to be synchronously obtained in the predetermined cycles. For example, a vehicle position may be estimated using the latest first error and the latest second errors which are obtained in cycles in which the vehicle position is estimated. In addition, photographing of a road around the vehicle does not necessarily need to be performed in predetermined cycles and may be performed anytime as long as photographing timing (photographing time) can be identified.

The first error, the second errors, and the third error each may have a value that directly represents length, and in that case, the values of length indicating errors may be directedly compared with each other. Alternatively, ranks that are associated with ranges of error values may be a first error, a second error, and a third error, and in that case, the magnitudes of errors may be compared with each other using the ranks. In that case, units of errors do not necessarily need to be the same between the first error, the second error, and the third error, and the ranges of values do not necessarily need to be the same between the first error, the second error, and the third error, either.

Furthermore, a technique of the present disclosure is also applicable as a program or a method. In addition, a system, a program, and a method such as those described above may be implemented as a single device or may be implemented by using a component that is used in a shared manner with a part included in a vehicle, and thus include various modes. In addition, changes can be made as appropriate, e.g., a part is software and a part is hardware. Furthermore, the aspects of the disclosure are also feasible as a recording medium for a program that controls the system. Needless to say, the recording medium for a program may be a magnetic recording medium or may be a semiconductor memory, and any recording medium to be developed in the future can also be considered exactly in the same manner.

### REFERENCE SIGNS LIST

10: Vehicle position estimation system, 20: Control part, 21: Vehicle position estimation program, 21d: Position estimating part, 30: Recording medium, 30a: Map information, 30b: Image recognition information, 41: GNSS receiving part, 42: Vehicle speed sensor, 43:6-axis sensor, 44: Camera, and 45: User I/F part

Listing of claims:

1. A vehicle position estimation system comprising:
a first error obtaining part that obtains a first error indicating an error in Global Navigation Satellite System (GNSS) information obtained by a vehicle;
a second error obtaining part that obtains a second error indicating an autonomous navigation error;
a third error obtaining part that obtains a third error indicating an error occurring upon detecting a marking included in an image obtained by photographing a road around the vehicle; and
a position estimating part that selects a position estimation method with a smallest error among the first error, the second error, and the third error, and estimates a position of the vehicle in a width direction of the road, using a selected position estimation method.

2. The vehicle position estimation system according to claim 1, wherein the position estimating part performs estimation of a position of the vehicle every predetermined cycle.

3. The vehicle position estimation system according to claim 1, wherein the third error is a difference between a lane width of a lane calculated based on a marking included in the image and a lane width of the lane identified based on map information, the lane being a lane in which the vehicle is traveling.

4. The vehicle position estimation system according to claim 3, wherein the lane width of a lane calculated based on a marking included in the image is accumulated in chronological order, and a comparison is made between a lane width at a point calculated based on the image including the point among accumulated lane widths, and a lane width at the point identified based on the map information, the point being a point where the vehicle is currently located.

5. The vehicle position estimation system according to claim 1, wherein the first error and the second error are errors in a width direction of the vehicle.

6. The vehicle position estimation system according to claim 2, wherein the first error, the second error, and the third error are calculated in the predetermined cycles.
